(19) United States
(12) Patent Application Publication
(10) Pub. No.: US 2012/0135314 A1
(43) Pub. Date: May 31, 2012

(54) ELECTROLYTE ADDITIVE, ELECTROLYTE INCLUDING THE SAME AND LITHIUMSECONDARY BATTERY INCLUDING THE ELECTROLYTE.

(75) Inventors: Eun Gi SHIM, Gyeonggi-do (KR); Ji Seong Han, Gyeonggi-do (KR); Ji Young Choi, Daegu (KR); Soo Young Kim, Gyeonggi-do (KR); Hyeong Kyu Lim, Daejeon (KR)

(73) Assignee: SOULBRAIN CO., LTD, Seongnam-si (KR)

(21) Appl. No.: 13/305,173

(22) Filed: Nov. 28, 2011

(30) Foreign Application Priority Data
Nov. 26, 2010 (KR) 10-2010-0118610

(51) Int. Cl. H01M 10/056

(52) U.S. Cl. 429/331; 429/341; 429/330

(57) ABSTRACT

Provided are an electrolyte additive represented by the following formula (1), an electrolyte solution containing the electrolyte additive, and a lithium secondary battery including the electrolyte solution:

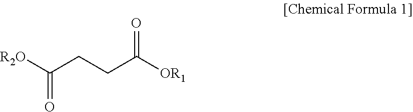

The electrolyte solution containing the electrolyte additive can enhance the normal-temperature and high-temperature lifetime characteristics of the battery to be equivalent or superior to the characteristics of conventional batteries, and can extend the service life of the battery.

### BACKGROUND OF THE INVENTION

1. Field of the Invention

The present invention relates to an electrolyte additive, an electrolyte solution containing the additive, and a lithium secondary battery including the electrolyte solution, and more particularly, to an electrolyte additive which has excellent normal-temperature and high-temperature lifetime characteristics, is capable of extending the service life of batteries, and has a discharge capacity increasing effect, an electrolyte solution containing the additive, and a lithium secondary battery including the electrolyte solution.

2. Description of Related Art

Along with the recent speedy development of electronic instruments such as mobile telephones and laptop computers, the use of lithium secondary batteries having a very high energy density and an excellent cycle lifetime as compared with the conventional NiMH batteries or NiCd batteries, is rapidly expanding.

As the use of lithium secondary batteries expands, there is a strong demand for excellent properties of secondary batteries in terms of safety, service life performance and capacity, in order to secure the safety of appliances and of users.

The average discharge voltage of lithium secondary batteries is about 3.6 to 3.7 V, and higher electric power can be obtained as compared with other alkaline batteries, Ni-MH batteries, Ni—Cd batteries and the like. However, in order to obtain such a high driving voltage, an electrolyte composition which is electrochemically stable in the charge-discharge voltage range of 0 V to 4.6 V, is required.

In a lithium secondary battery, lithium ions migrate from the cathode to the anode at the time of initial charging, and are intercalated in the anode. At this time, lithium reacts with the anode to produce Li₂CO₃, LiO, LiOH and the like, and forms a film on the surface of the anode. Such a film is referred to as a solid electrolyte interface (SEI) film.

An SEI film that is formed in the early phase of charging prevents reactions of lithium ions with the anode or other substances during the charging-discharging process. Furthermore, an SEI film serves as an ion tunnel, thereby allowing only lithium ions to pass through.

The ion tunnel has a function of solvating lithium ions and thereby preventing the organic solvents of the electrolyte having large molecular weights, which migrate together with the lithium ions, from being co-intercalated together with lithium ions in the carbon anode and destroying the structure of the anode. The ion tunnel also prevents the occurrence of side reactions between lithium ions and other substances.

In order to improve the storage properties and stability of batteries, it is necessary to form an SEI film stably, and a method for enhancing the stability, service life performance and capacity of batteries is needed.

### SUMMARY OF THE INVENTION

An object of the present invention is to provide an electrolyte additive which has excellent normal-temperature and high-temperature lifetime characteristics, is capable of extending the service life of batteries, and has a discharge capacity increasing effect. Another object of the present invention is to provide an electrolyte solution containing the electrolyte additive of the present invention, and a lithium secondary battery including the electrolyte solution.

According to an aspect of the present invention, there is provided an electrolyte additive represented by the following formula (1):

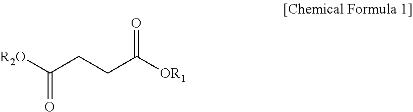

wherein in the formula (1),

R₁ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms; and R₂ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl having 6 to 30 carbon atoms.

Examples of the electrolyte additive include methyl succinate, ethyl succinate, propyl succinate, butyl succinate, dimethyl succinate, diethyl succinate, dipropyl succinate, dibutyl succinate and combinations thereof.

According to another aspect of the present invention, there is provided an electrolyte solution containing an organic solvent, a lithium salt, and an electrolyte additive represented by the following formula (1):

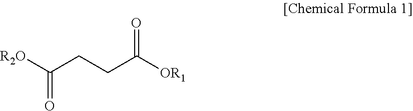

wherein R₁ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms; and R₂ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms.

Examples of the electrolyte additive include methyl succinate, ethyl succinate, propyl succinate, butyl succinate, dimethyl succinate, diethyl succinate, dipropyl succinate, dibutyl succinate, and combinations thereof.

The content of the electrolyte additive may be 0.1% to 30% by weight relative to the total amount of the electrolyte solution.

Examples of the organic solvent include ethylene carbonate (EC), propylene carbonate (PC), ethyl methyl carbonate (EMC), dimethyl carbonate (DMC), diethyl carbonate (DEC), fluoroethylene carbonate (FEC), methyl propyl carbonate (MPC), ethyl propyl carbonate (EPC), methyl ethyl carbonate (MEC), butylene carbonate (BC) and mixtures thereof.

The organic solvent may contain 10% to 30% by weight of ethylene carbonate (EC), 0% to 30% by weight of fluoroethylene carbonate (FEC), 10% to 50% by weight of ethyl methyl carbonate (EMC), and 10% to 40% by weight of diethyl carbonate (DEC), relative to the total solution of the organic solvent.

According to another aspect of the present invention, there is provided a lithium secondary battery which includes a cathode containing a cathode active material, an anode containing an anode active material, and the electrolyte described above.

Hereinafter, the present invention will be described in more detail.

The terms used in the present specification are defined as follows.

Unless particularly stated otherwise in the present specification, the term “alkyl group” includes a primary alkyl group, a secondary alkyl group and a tertiary alkyl group.

Unless particularly stated otherwise, all of the compounds and substituents mentioned herein may be substituted or unsubstituted. Here, the term “substituted” means that a hydrogen atom has been substituted with any one selected from the group consisting of a halogen atom, a hydroxyl group, a carboxyl group, a cyano group, a nitro group, an amino group, a thio group, a methylthio group, an alkoxy group, a nitrile group, an aldehyde group, an epoxy group, an ether group, an ester group, a carbonyl group, an acetal group, a ketone group, an alkyl group, a cycloalkyl group, a heterocycloalkyl group, an allyl group, a benzyl group, an aryl group, a heteroaryl group, derivatives thereof and combinations thereof.

Unless particularly stated otherwise herein, the term “cycloalkyl group” includes a monocyclic alkyl group, a bicyclic alkyl group, a tricyclic alkyl group, and a tetracyclic alkyl group. Furthermore, the “cycloalkyl group” includes polycyclic cycloalkyl groups such as an adamantyl group and a norbornyl group.

According to an embodiment of the present invention, there is provided an electrolyte additive represented by the following formula (1):

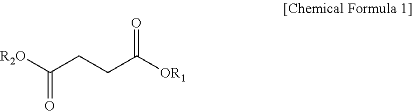

wherein in the formula (1), R₁ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms; and

R₂ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms.

R₁ and R₂ may each independently represent any one selected from the group consisting of a hydrogen atom, an alkyl group having 1 to 8 carbon atoms, a cycloalkyl group having 3 to 12 carbon atoms, an aryl group having 6 to 20 carbon atoms and an arylalkyl group having 6 to 20 carbon atoms.

When the compound of the formula (1) is used as an electrolyte additive, a battery which includes an electrolyte containing the additive has excellent service life performance and is capable of suppressing the decomposition of the solvent at the time of high rate discharge at normal temperature.

The electrolyte additive may be an alkyl succinate in which R1 and R2 in the formula (1) may each independently represent a hydrogen atom and an alkyl group having 1 to 20 carbon atoms.

When the alkyl succinate is used as the electrolyte additive, a lithium secondary battery exhibiting normal-temperature and high-temperature lifetime characteristics that are equivalent or superior to conventional batteries can be produced, and the discharge capacity can be increased.

Examples of the electrolyte additive include methyl succinate, ethyl succinate, propyl succinate, butyl succinate, dimethyl succinate, diethyl succinate, dipropyl succinate, dibutyl succinate, and combinations thereof. The electrolyte additive is preferably any one selected from the group consisting of methyl succinate, dimethyl succinate, and combinations thereof.

When any one selected from the group consisting of ethyl succinate, diethyl succinate and combinations thereof is used as the electrolyte additive, excellent lifetime characteristics at normal temperature and high temperature can be obtained, and the discharge capacity can be increased.

When a compound of the formula (1) is used as the electrolyte additive, the electrolyte additive can be decomposed earlier than the organic solvent contained in the electrolyte solution at the time of high rate discharge of the battery at normal temperature. Therefore, the electrolyte additive can effectively form a solid electrolyte interface (SEI) film on the anode surface, and allows lithium ions to be easily inserted into the electrode surface.

According to another embodiment of the present invention, there is provided an electrolyte solution containing an organic solvent, a lithium salt, and the electrolyte additive represented by the formula (1).

Any organic solvent can be used as long as the solvent can serve as a medium which enables the migration of those ions that participate in the electrochemical reaction of the battery, and specific examples of the organic solvent include an ester solvent, an ether solvent, a ketone solvent, an aromatic hydrocarbon solvent, a carbonate solvent, and combinations thereof.

Examples of the ester solvent that can be used include n-methyl acetate, n-ethyl acetate, and n-propyl acetate.

As the organic solvent, a carbonate solvent can be used with preference, and examples of the carbonate solvent include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethyl methyl carbonate (EMC), ethylene carbonate (EC), propylene carbonate (PC), butylene carbonate (BC), vinylene carbonate (VC), fluoroethylene carbonate (FEC), and combinations thereof.

The organic solvents described above can be used as mixtures, and mixtures of ethylene carbonate, fluoroethylene carbonate, diethylene carbonate, ethyl methyl carbonate and vinylene carbonate can be used.

Furthermore, any one selected from the group consisting of ethylene carbonate, propylene carbonate and combinations thereof, and any one selected from the group consisting of ethyl methyl carbonate, dimethyl carbonate, diethyl carbonate and combinations thereof can be used in mixture. In such a case, a high dielectric constant solvent which has high ion conductivity so that the charge-discharge performance of the battery can be increased, and an organic solvent with low viscosity which can appropriately adjust the viscosity of the high dielectric constant solvent can be used as a mixture, and a solvent mixture which has a high dielectric constant and an appropriate viscosity can be applied as the organic solvent.

The organic solvent can contain 10% to 30% by weight of ethylene carbonate (EC), 0% to 30% by weight of fluoroethylene carbonate (FEC), 10% to 50% by weight of ethyl methyl carbonate, and 10% to 40% by weight of diethyl carbonate (DEC), relative to the total amount of the organic solvent. In the case of using an organic solvent prepared by incorporating the organic solvents mentioned above at the contents described above, the charge-discharge performance of the battery can be improved, and the lifetime characteristics can also be enhanced.

In regard to the lithium salt, any compound capable of providing lithium ions to be used in a lithium ion secondary battery can be used, and examples of the lithium salt include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₓF₂ₓ₊₁SO₂)(C_{y}F_{2y+1}SO₂) (wherein x and y each represent a natural number), LiCl, LiI and combinations thereof. The lithium salt is preferably lithium hexafluorophosphate (LiPF₆).

When the lithium salt is contained in the electrolyte solution, the lithium salt is dissolved in the electrolyte solution to act as a source for lithium ions in the battery, and can accelerate the movement of lithium ions between the cathode and the anode.

The lithium salt may be incorporated into the electrolyte solution in an amount of 0.6 to 2 moles per liter, and preferably 0.7 to 1.6 moles per liter. If the concentration of the lithium salt is less than 0.6 moles per liter, the conductivity of the electrolyte is lowered, and the electrolyte performance may deteriorate. If the concentration of the lithium salt is greater than 2 moles per liter, the viscosity of the electrolyte solution increases, and the mobility of the lithium ions may deteriorate.

The details of the electrolyte additive represented by the formula (1) are the same as described above with regard to the electrolyte additive, and therefore, further description will not be repeated here.

The electrolyte additive can be incorporated into the electrolyte solution in an amount of 0.1% to 30% by weight, and preferably in an amount of 1% to 10% by weight, relative to the total amount of the electrolyte solution.

If the electrolyte additive is contained in the electrolyte solution in an amount of less than 0.1% by weight, the effect of incorporating the electrolyte additive may be negligible. If the electrolyte additive is contained in an amount of greater than 30% by weight, the effect of increasing the charge-discharge efficiency may be negligible, and the service life performance may deteriorate.

The electrolyte solution may further contain an additive that can be generally contained in electrolyte solutions (hereinafter, referred to as other additive), in addition to the electrolyte additive of the present invention.

A specific example of the other additive may be a metal fluoride. When a metal fluoride is incorporated into the electrolyte solution as the other additive, the influence of the acid produced in the vicinity of the cathode active material is decreased, and the reaction between the cathode active material and the electrolyte solution is suppressed, so that the phenomenon in which the battery capacity is drastically decreased can be ameliorated.

Specific examples of the metal fluoride include LiF, RbF, TiF, AgF, AgF₂, BaF₂, CaF₂, CdF₂, FeF₂, HgF₂, Hg₂F₂, MnF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, InF₃, LaF₃, LuF₃, MnF₃, NdF₃, PrF₃, SbF₃, ScF₃, SmF₃, TbF₃, TiF₃, TmF₃, YF₃, YbF₃, TIF₃, CeF₄, GeF₄, HfF₄, SiF₄, SnF₄, TiF₄, VF₄, ZrF4₄, NbF₅, SbF₅, TaF₅, BiF₅, MoF₆, ReF₆, SF₆, WF₆, CoF₂, CoF₃, CrF₂, CsF, ErF₃, PF₃, PbF₃, PbF₄, ThF₄, TaF₅, SeF₆ and combinations thereof.

The electrolyte solution can contain, as the other additive, any one selected from the group consisting of glutaronitrile (GN), succinonitrile (SN), adiponitrile (AN), 3,3′-thiodipropiodinitrile (TPN), and combinations thereof, and when the electrolyte solution further contains such an other additive, the discharge capacity and the lifetime characteristics of the battery can be improved.

It is preferable that the electrolyte solution contain, as the other additive, succinonitrile (SN) in an amount of 0.3% to 30% by weight based on the organic solvent, and in this case, the discharge capacity and the lifetime characteristics of the battery can be improved.

According to another embodiment of the present invention, there is provided a lithium secondary battery which includes a cathode containing a cathode active material, an anode containing an anode active material, and the electrolyte solution described above.

FIG. 1 is an exploded perspective view of a lithium secondary battery (1) according to an embodiment of the present invention. FIG. 1 depicts a pouch type secondary battery, but the lithium secondary battery of the present invention is not intended to be limited to this configuration, and any configuration can be employed as long as the battery is capable of functioning as a battery.

According to FIG. 1, a lithium secondary battery (1) according to another embodiment of the present invention is produced by constructing an electrode assembly (9) by disposing an anode (3), a cathode (5), and a separator (7) between the anode (3) and the cathode (5); disposing the electrode assembly in a casing (15); and pouring a non-aqueous electrolyte to impregnate the anode (3), the cathode (5) and the separator (7) with the electrolyte.

The anode (3) and the cathode (5) may be respectively equipped with an electrically conductive lead member for collecting the electric current generated at the time of battery operation, and the lead members may lead the electric currents generated at the cathode and the anode toward the cathode terminal and the anode terminal, respectively.

The cathode (5) can be produced by mixing a cathode active material, an electrical conductive agent and a binder to prepare a composition for cathode active material layer formation, subsequently applying the composition for cathode active material layer formation on a cathode current collector such as an aluminum foil, and then rolling the cathode current collector.

As the cathode active material, a compound capable of reversible intercalation and deintercalation of lithium (lithiated intercalation compound) can be used. Specifically, an olivine type compound represented by the following formula (2) can be used.

LiₓM_{y}M′_{z}XO_{4-w}B_{w} [Chemical Formula 2]

wherein in the formula (2),

M and M′ each independently represent an element selected from the group consisting of iron (Fe), nickel (Ni), cobalt (Co), manganese (Mn), chromium (Cr), zirconium (Zr), niobium (Nb), copper (Cu), vanadium (V), molybdenum (Mo), titanium (Ti), zinc (Zn), aluminum (Al), gallium (Ga), magnesium (Mg), boron (B) and combinations thereof; X represents an element selected from the group consisting of phosphorus (P), arsenic (As), bismuth (Bi), antimony (Sb), molybdenum (Mo) and combinations thereof; B represents an element selected from the group consisting of fluorine (F), sulfur (S) and a combination thereof; x, y, z and w are such that 0≦x≦1, 0<y≦1, 0<z≦1, 0<x+y+z≦2, and 0≦w≦0.5.

The cathode active material is preferably any one lithium metal oxide selected from the group consisting of LiCoO₂, LiMnO₂, LiMn₂O₄, LiNiO₂, (provided that 0<x<1), LiM₁ₓM_{2y}O₂ (provided that 0≦x≦1, 0≦y≦1, 0≦x+y≦1, and wherein M₁ and M₂ each independently represent any one selected from the group consisting of aluminum (Al), strontium (Sr), magnesium (Mg) and lanthanum (La)), and combinations thereof.

When a lithium metal oxide is used as the cathode active material, a high capacity battery with increased stability can be obtained.

The anode (3) can also be produced in the same manner as in the case of the cathode (5), by mixing a cathode active material, a binder, and optionally an electrically conductive agent to prepare a composition for cathode active material layer formation, and then applying the composition on a cathode current collector such as a copper foil.

As the anode active material, a compound capable of reversible intercalation and deintercalation of lithium can be used. Specific examples of the anode active material that can be used include carbonaceous materials such as artificial graphite, natural graphite, graphitized carbon fiber, and amorphous carbon. Furthermore, in addition to the carbonaceous materials described above, a metallic compound which can be alloyed with lithium, or a composite containing a metallic compound and a carbonaceous material can also be used as the anode active material.

Examples of a metal which can be alloyed with lithium include silicon (Si), aluminum (Al), tin (Sn), lead (Pb), zinc (Zn), bismuth (Bi), indium (In), magnesium (Mg), gallium (Ga), cadmium (Cd), an Si alloy, an Sn alloy, and an Al alloy. Furthermore, a lithium metal thin film can also be used as the anode active material.

In view of high stability, any one selected from the group consisting of crystalline carbon, amorphous carbon, a carbon composite, lithium metal; an alloy containing lithium, and combinations thereof can be used as the anode active material.

The cathode may be a product produced by applying LiCoO₂ as the cathode active material, carbon black as the conductive agent, polyvinylidene fluoride (PVDF) as the binder, and n-methyl-2-pyrrolidone (NMP) as the solvent, and coating an Al substrate with a mixture of the components described above. The anode may be a product produced by preparing a slurry which uses mesocarbon microbeads (MCMB), which is an artificial graphite, carbon black as the conductive agent, and PVDF as the binder, and NMP as the solvent, and coating a Cu substrate with the slurry.

The electrolyte solution contains the electrolyte additive of the present invention. In regard to the electrolyte additive and the electrolyte solution, the details of the electrolyte additive and the electrolyte solution are the same as described above with regard to the electrolyte additive and the electrolyte solution, and therefore, further description will not be repeated here.

The electrolyte solution containing the electrolyte additive of the present invention has excellent stability in the temperature range of from −20° C. to 60° C., and can be electrochemically stable at a voltage of about 4 V. Thus, when the electrolyte solution containing the electrolyte additive of the present invention is applied to a lithium secondary battery, the service life of the battery can be extended.

Lithium secondary batteries can be classified into lithium ion batteries, lithium ion polymer batteries and lithium polymer batteries depending on the types of the separator and the electrolyte used, and can also be classified, according to the shape, into a cylindrical shape, a box type, a coin type, a pouch type and the like. Lithium secondary batteries can also be classified, according to the size, into bulk type and thin film type.

The electrolyte solution containing the electrolyte additive of the present invention is particularly excellent to be applied to lithium ion batteries, aluminum-laminated batteries, and lithium polymer batteries.

The lithium secondary battery of the present invention is produced by a conventional method, and the battery produced by using the electrolyte solution containing the electrolyte additive of the present invention has normal-temperature and high-temperature lifetime characteristics that are equivalent or superior to conventional batteries, has an extended battery service life, and has an increased discharge capacity.

The electrolyte additive of the present invention, when contained in an electrolyte solution, can improve the normal-temperature and high-temperature service life characteristics of the battery to be equivalent or superior to conventional batteries, can extend the service life of the battery, and can increase the discharge capacity.

### BRIEF DESCRIPTION OF THE DRAWINGS

FIG. 1 is an exploded perspective view of a lithium secondary battery according to an embodiment of the present invention.

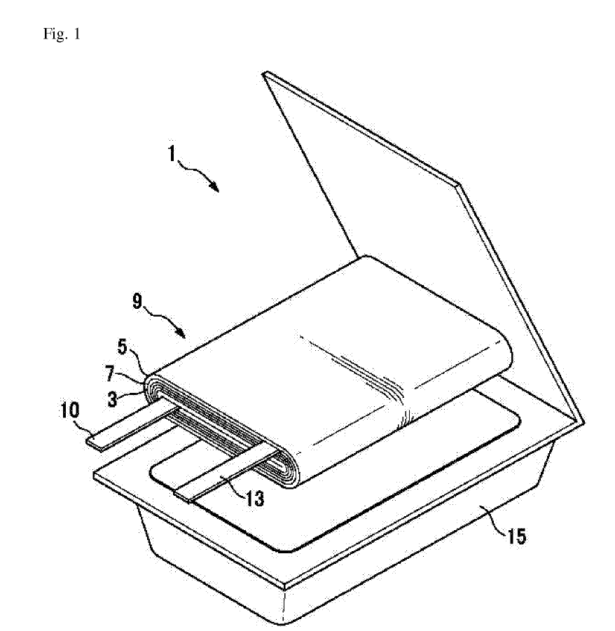

FIG. 2 is a graph showing the rated capacity performance (1^{st}, 0.2 C-0.2 C) of the battery according to Example 1 (solid line) and the battery according to Comparative Example 1 (broken line).

FIG. 3 is a graph showing the rate performance (discharge at 0.5 C) of the battery according to Example 1 (solid line) and the battery according to Comparative Example 1 (broken line).

FIG. 4 is a graph showing the rate performance (discharge at 1.0 C) of the battery according to Example 1 (solid line) and the battery according to Comparative Example 1 (broken line).

FIG. 5 is a graph showing the service life characteristics at a high temperature (45° C.) of the battery according to Example 1 (solid line) and the battery according to Comparative Example 1 (broken line).

### DESCRIPTION ON REFERENCE NUMERALS

3 Anode
5 Cathode
7 Separator
9 Electrode assembly
15 Casing

### DETAILED DESCRIPTION OF THE INVENTION

Hereinafter, the present invention will be described in detail by way of Examples, with reference to the attached drawings, so that a person having ordinary skill in the art to which the present invention is pertained, can easily carry out the invention. However, the present invention can be carried out in a variety of variations and modifications, and is not intended to be limited to the Examples described herein.

### Preparation Examples for Electrolyte Solution and Lithium Secondary Cell

Hereinafter, ethylene carbonate will be abbreviated to EC; fluoroethylene carbonate to FEC; ethyl methyl carbonate to EMC; diethylene carbonate to DEC; and vinylene carbonate to VC.

In the following experiments, LiCoO₂ as a cathode active material, carbon black as a conductive agent, PVDF (polyvinylidene fluoride) as a binder, and NMP (n-methyl-2-pyrrolidone) as a solvent were mixed, and then the mixture was applied on an Al substrate. The resulting product was used as the cathode. Furthermore, a slurry was prepared by using mesocarbon microbeads (MCMB), which is an artificial graphite, carbon black, and PVDF as a binder, and NMP as a solvent, and the slurry was applied on a Cu substrate. The resulting product was used as the anode.

In the following descriptions, percent (%) means percent by weight (wt %).

### Example 1

A solvent was prepared by adding vinylene carbonate (VC) in an amount of 0.5% by weight to a mixed solution of ethylene carbonate (EC), fluoroethylene carbonate (FEC), ethyl methyl carbonate (EMC) and diethylene carbonate (DEC) (weight ratio: EC/FEC/EMC/DEC=2/2/4/2). Subsequently, LiPF₆ was added to the solvent to a concentration of 1.4 M, and thus, an organic solvent containing a lithium salt was prepared. Subsequently, ethyl succinate was added to the organic solvent containing a lithium salt, and thus, an electrolyte solution containing ethyl succinate at a concentration of 5% by weight was prepared. An aluminum pouch type (Al-pouch type) lithium secondary cell was produced using the electrolyte solution thus prepared (hereinafter, referred to as cell A).

### Comparative Example 1

An electrolyte solution was prepared from the organic solvent containing a lithium salt described above, without adding ethyl succinate. A lithium secondary cell was produced in the same manner as in Example 1, except that the electrolyte solution prepared without ethyl succinate was used as the electrolyte solution (hereinafter, referred to as cell B).

### Example 2

A solvent was prepared by adding vinylene carbonate (VC) in an amount of 1.0% by weight to a mixed solution of ethylene carbonate (EC), fluoroethylene carbonate (FEC), ethyl methyl carbonate (EMC) and diethylene carbonate (DEC) (weight ratio: EC/FEC/EMC/DEC=1/1/6/2), and succinonitrile (SN) was added to the solvent in an amount of 4% by weight. Subsequently, LiPF₆ was added to the solvent to a concentration of 1.4 M, and thus, an organic solvent containing a lithium salt was prepared. Subsequently, ethyl succinate was added to the organic solvent containing a lithium salt, and thus, an electrolyte solution containing ethyl succinate at a concentration of 2% by weight was prepared. An aluminum pouch type (Al-pouch type) lithium secondary cell was produced using the electrolyte solution thus prepared (hereinafter, referred to as cell C).

### Comparative Example 2

An electrolyte solution was prepared from the organic solvent containing a lithium salt described above, without adding ethyl succinate. A lithium secondary cell was produced in the same manner as in Example 2, except that the electrolyte solution prepared without ethyl succinate was used as the electrolyte solution (hereinafter, referred to as cell D).

### Properties Evaluation of Lithium Secondary Cells

### Comparison of Properties of Example 1 and Comparative Example 1

1. Evaluation of Rate Capacity and Rate Performance

Cell A and cell B produced in the Production Examples were respectively charged to 4.2 V (cut-off: 22 mAh) with a current of 220 mAh under the CC (constant current)/CV (constant voltage) conditions, and then were discharged to 3.0 V with a current of 220 mAh. Subsequently, the gas generated at the time of charge-discharge was removed by applying a vacuum.

The degassed cell A and cell B were respectively charged again at a charging voltage of 4.2 V with a current of 440 mAh under the CC/CV conditions, and then were discharged to 3.0 V with a current of 1100 mAh under the CC conditions. The cells were respectively charged again in the same manner as described above, and then were discharged to 3.0 V with a current of 2200 mAh under the CC conditions.

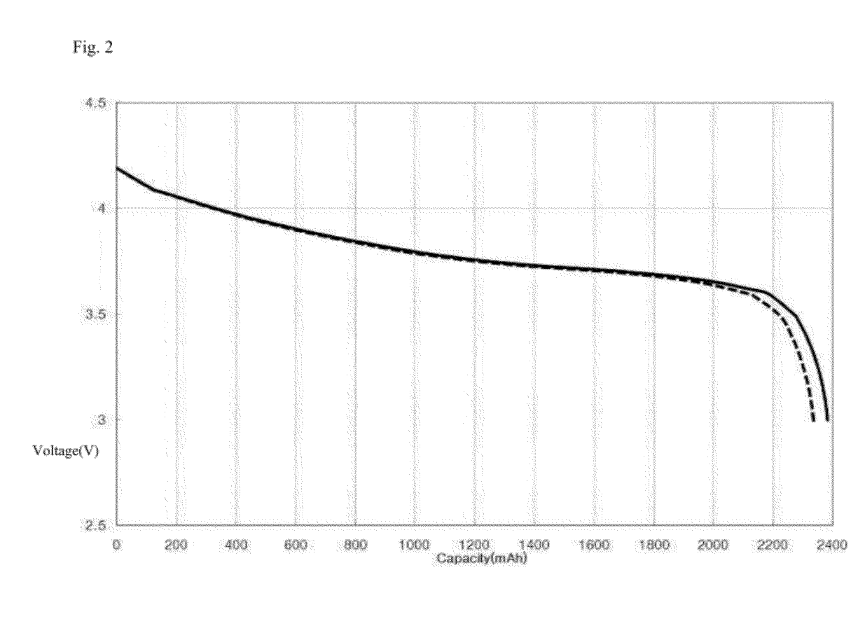

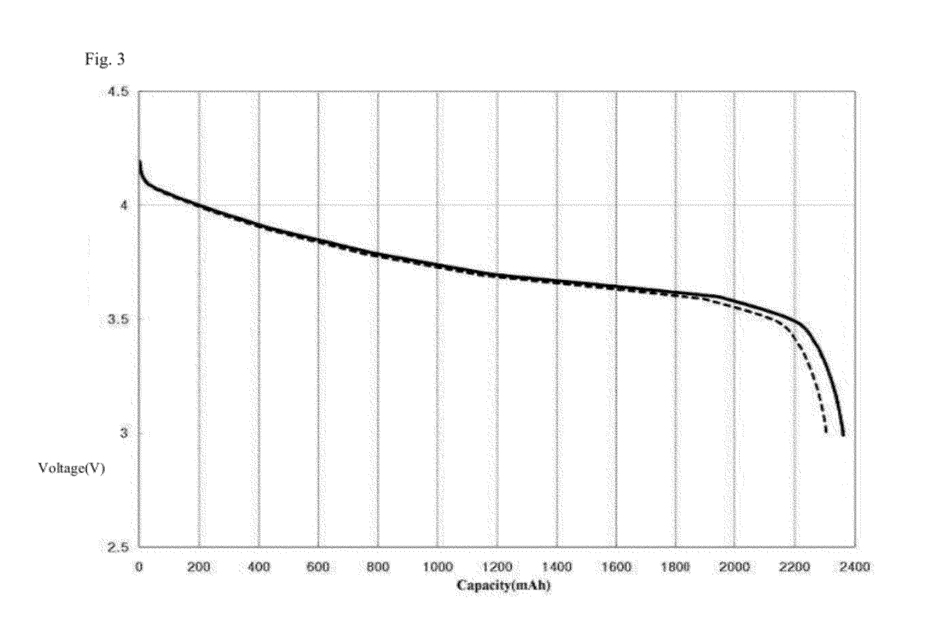

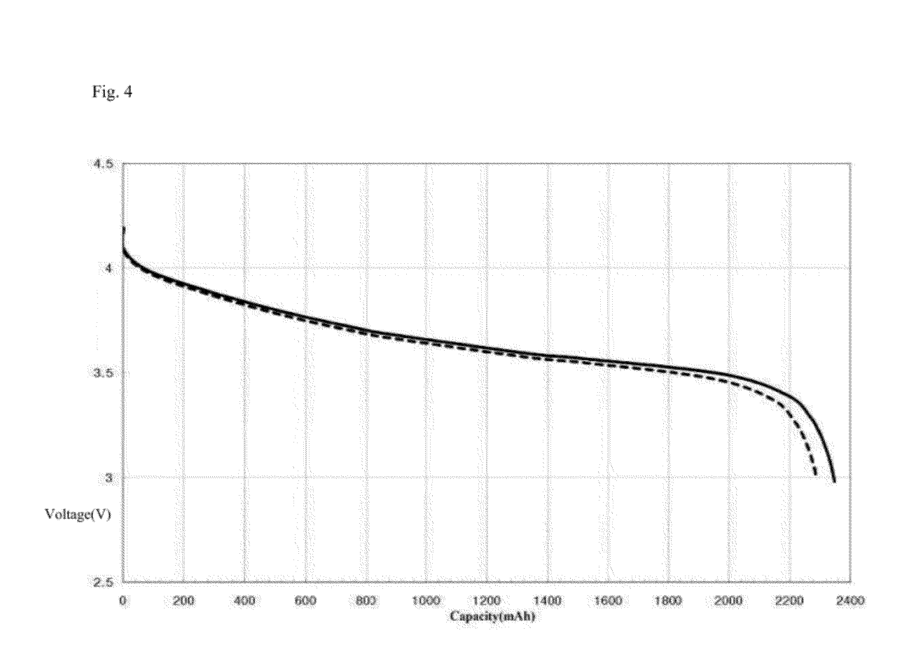

The initial capacity and the rate performance (normal temperature, 25° C.) of the cells were measured in the process described above, and the results are presented in FIG. 2 to FIG. 4.

It can be confirmed from FIG. 2 to FIG. 4 that the cell A of Example 1 is superior to the cell B of Comparative Example 1 in terms of the initial capacity and the rate performance.

2. Evaluation of Normal-Temperature and High-Temperature Lifetime Characteristics

The cell A and cell B were respectively charged to 4.2 V (cut-off: 11 mAh) with a current of 1100 mAh under the CC (constant current)/CV (constant voltage) conditions, and then were discharged to 3.0 V with a current of 1100 mAh. This procedure was repeated 100 times, and the lifetime characteristics (cycle performance) were measured.

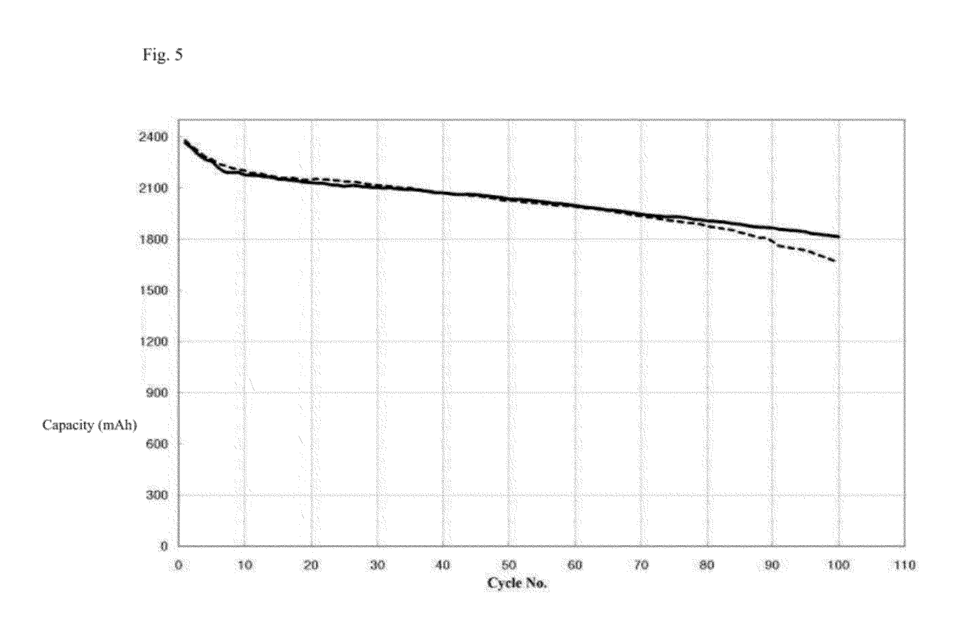

The evaluation of cycle performance was carried out at normal temperature (25° C.) and at a high temperature (45° C.), and the results are presented in the following Table 1. The high temperature lifetime characteristics results are presented in FIG. 5.

TABLE 1

| | | | | Capacity |
|---|---|---|---|---|
| | | 1 | 100 | retention |
| | | cycle | cycles | (%) |
| Normal temperature lifetime | Cell A | 2315 | 2238 | 97 |
| | Cell B | 2317 | 2244 | 97 |
| High temperature lifetime | Cell A | 2345 | 1847 | 79 |
| | Cell B | 2379 | 1662 | 70 |

According to the results of Table 1, the cell A produced in Example 1 exhibited normal-temperature and high-temperature lifetime characteristics that were equivalent or superior to the characteristics of the cell B of Comparative Example 1. Particularly, the cell A exhibited excellent characteristics at high temperature.

### Comparison of Properties of Example 2 and Comparative Example 2

1. Evaluation of Rate Capacity and Rate Performance

Cell C and cell D produced in the Production Examples were respectively charged to 4.4 V (cut-off: 46 mAh) with a current of 460 mAh under the CC (constant current)/CV (constant voltage) conditions, and then were discharged to 3.0 V with a current of 460 mAh. Subsequently, the gas generated at the time of charge-discharge was removed by applying a vacuum.

The degassed cell C and cell D were respectively charged again at a charging voltage of 4.4 V with a current of 460 mAh under the CC/CV conditions, and then were discharged to 3.0 V with a current of 2300 mAh under the CC conditions. The cells were respectively charged again in the same manner as described above, and then were discharged to 3.0 V with a current of 4600 mAh under the CC conditions.

The initial capacity and the rate performance (normal temperature, 25° C.) of the cells were measured in the process described above, and the results are presented in the following Table 2.

TABLE 2

| | | Charge | Discharge | |
|---|---|---|---|---|
| Initial capacity and | | capacity | capacity | Efficiency |
| rate performance | | (mAh) | (mAh) | (%) |
| 0.2C_1st cycle | Cell C | 2594.6 | 2418.6 | 93.2 |
| | Cell D | 2581.5 | 2404.3 | 93.1 |
| 0.2C | Cell C | 2411.9 | 2404.4 | 99.6 |
| | Cell D | 2398.2 | 2382.9 | 99.3 |
| 1.0C | Cell C | 2407.8 | 2384.6 | 99.0 |
| | Cell D | 2394.6 | 2367.7 | 98.8 |
| 2.0C | Cell C | 2387.0 | 2362.6 | 98.9 |
| | Cell D | 2370.8 | 2351.8 | 99.1 |

According to the results of Table 2, it can be confirmed that the cell C of Example 2 is superior to the cell D of Comparative Example 2 in terms of the rated capacity, and the cell C has an initial discharge capacity and rate performance that are equivalent to the cell D.

2. Evaluation of Normal Temperature Lifetime Characteristics

The cell C and cell D were respectively charged to 4.4 V (cut-off: 46 mAh) with a current of 1100 mAh under the CC (constant current)/CV (constant voltage) conditions, and then were discharged to 3.0 V with a current of 1100 mAh. This procedure was repeated 100 times, and the lifetime characteristics (cycle performance) were measured.

The evaluation of cycle performance was carried out at normal temperature (25° C.), and the results are presented in the following Table 3.

According to the results of Table 3, it can be seen that the cell C produced in Example 2 of the present invention has lifetime characteristics at normal temperature that are equivalent or superior to the characteristics of the cell D of Comparative Example 1.

TABLE 3

| | | | | Capacity |
|---|---|---|---|---|
| | | 1 | 100 | retention |
| | | cycle | cycles | (%) |
| Normal temperature lifetime | Cell C | 2682.6 | 2577.6 | 96.0 |
| | Cell D | 2662.3 | 2569.8 | 96.5 |

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An electrolyte additive represented by the following formula (1): 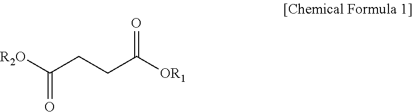
wherein in the formula (1),
R₁ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms; and
R₂ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms.

2. The electrolyte additive according to claim 1, wherein the electrolyte additive is any one selected from the group consisting of methyl succinate, ethyl succinate, propyl succinate, butyl succinate, dimethyl succinate, diethyl succinate, dipropyl succinate, dibutyl succinate, and combinations thereof.

3. An electrolyte solution for lithium secondary batteries comprising:
an organic solvent;
a lithium salt; and
an electrolyte additive represented by the following formula (1): 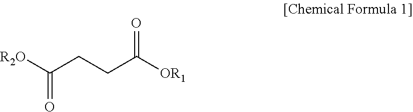
wherein in the formula (1),
R₁ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms; and
R₂ represents any one selected from the group consisting of a hydrogen atom, an alkyl group having 1 to 20 carbon atoms, a cycloalkyl group having 3 to 20 carbon atoms, an aryl group having 6 to 30 carbon atoms, and an arylalkyl group having 6 to 30 carbon atoms.

4. The electrolyte solution for lithium secondary batteries according to claim 3, wherein the electrolyte additive is any one selected from the group consisting of methyl succinate, ethyl succinate, propyl succinate, butyl succinate, dimethyl succinate, diethyl succinate, dipropyl succinate, dibutyl succinate, and combinations thereof.

5. The electrolyte solution for lithium secondary batteries according to claim 3, wherein the electrolyte additive is incorporated in an amount of 0.1% to 30% by weight relative to the total amount of the electrolyte solution.

6. The electrolyte solution for lithium secondary batteries according to claim 3, wherein the organic solvent is any one selected from the group consisting of ethylene carbonate (EC), propylene carbonate (PC), ethyl methyl carbonate (EMC), dimethyl carbonate (DMC), diethyl carbonate (DEC), fluoroethylene carbonate (FEC), methyl propyl carbonate (MPC), ethyl propyl carbonate (EPC), methyl ethyl carbonate (MEC), butylene carbonate (BC) and combinations thereof.

7. The electrolyte solution for lithium secondary batteries according to claim 3, wherein the organic solvent contains 10% to 30% by weight of ethylene carbonate (EC), 0% to 30% by weight of fluoroethylene carbonate (FEC), 10% to 50% by weight of ethyl methyl carbonate (EMC), and 10% to 40% by weight of diethyl carbonate (DEC), relative to the total amount of the organic solvent.

8. A lithium secondary battery comprising:
a cathode containing a cathode active material;
an anode containing an anode active material; and
the electrolyte solution for lithium secondary batteries according to claim 3.

9. A lithium secondary battery comprising:
a cathode containing a cathode active material;
an anode containing an anode active material; and
the electrolyte solution for lithium secondary batteries according to claim 4.

10. A lithium secondary battery comprising:
a cathode containing a cathode active material;
an anode containing an anode active material; and
the electrolyte solution for lithium secondary batteries according to claim 5.

11. A lithium secondary battery comprising:
a cathode containing a cathode active material;
an anode containing an anode active material; and
the electrolyte solution for lithium secondary batteries according to claim 6.

12. A lithium secondary battery comprising:
a cathode containing a cathode active material;
an anode containing an anode active material; and
the electrolyte solution for lithium secondary batteries according to claim 7.
